(19) United States
(12) Patent Application Publication
(10) Pub. No.: US 2004/0234269 A1
(43) Pub. Date: Nov. 25, 2004

(54) Method of establishing a subscriber connection and system utilizing the method

(76) Inventors: Heikiki Laamanen, Espoo (FI); Umesh Gowda, Espoo (FI)

Correspondence Address: Shalom Wertsberger, Saltamr Innovations, 30 Fern Lane, South Portland, ME, 04106, US

(21) Appl. No.: 10/486,245

(22) PCT Filed: Aug. 14, 2002
(86) PCT No.: PCT/FI02/00671

(30) Foreign Application Priority Data
Aug. 17, 2001 (FI) 20011665

(51) Int. Cl. H04B 10/00

(52) U.S. Cl. 398/135; 398/139; 398/140

(57) ABSTRACT

The objective of the invention is a method for establishing a subscriber connection and a system applying the method. According to the method, a digital subscriber connection of the FTTC type, consisting of a composition of an optical fiber and a metallic pair cable, is implemented by means of subscriber-specific DSL modems, whereby (a) a subscriber connection comprises an optical fiber (3), a metallic pair cable (6), and equipment (8) adapting the said fiber and cable to each other so that the optical fiber goes towards the telephone exchange or conentrator and the pair cable goes towards the subscriber, and (b) each DSL modem comprises digital transmitter and receiver elements (21,22) connected functionally to analog parts (5) that are adapted to convert (i) the digital output signal of the digital transmitter element (21) into analog form and (ii) the analog signal intended for the receiver element (22) into digital form. In accordance with the method, the analog parts (5) of the DSL modems are inserted into the said equipment (8), the digital signal produced by the DSL modem transmitter element (21) is transferred to the respective analog parts (5) through the optical fiber (3), and the digital signal produced by the DSL modem analog parts (5) is transferred to the respective digital receiver element (22) through the said fiber.

The invention relates to a method according to the preamble of claim 1 and a system according to claim 9.

Accordingly, the invention consists of a method of establishing a digital FTTC (Fiber To The Curb, Fiber To The Cabinet) subscriber connection comprising an optical fiber and a metallic twisted pair cable. The invention also consists of converter equipment connecting the fiber and the cable, the said converter equipment being an integral element of such subscriber connection.

### BACKGROUND OF THE INVENTION

In a conventional subscriber network based on a twisted metallic pair cable, each subscriber is connected to the local telephone exchange or concentrator via his own cable pair. A typical length of cable may be several kilometers. If the pair cable is utilized for transmitting digital information by means of DSL modem techniques, the transfer characteristics of the cable limit the highest achievable transmission rate from a few hundred kilobits per second to a few megabits per second, strongly depending on the cable length.

Subsequently the term “central site” represents the local telephone exchange or concentrator site.

When utilizing a conventional subscriber network for digital transmission, the signal conversion in the interface of the subscriber cable and the trunk network is typically carried out by DSLAM equipment (Digital Subscriber Line Access Multiplexer). A DSLAM comprises DSL modems, which transform the digital signal into analog form suitable for transmission over the metallic cable. The DSL modems also receive the signal coming from the far end subscriber transmitter and convert the signal into digital form. Furthermore, the DSLAM multiplexes traffic from several subscribers and transmits the traffic to the trunk network.

In a digital FTTC subscriber network, data streams from several subscribers are multiplexed to an optical fiber and transported over the fiber closer to the subscribers so that the lengths of the metallic pair cables are substantially shorter as compared to a conventional subscriber network. As a consequence, the digital transmission speed can be increased considerably, because the shorter the cable is, the higher is the usable bandwidth. A new problem arises in an FTTC network from the fact that now the DSLAM is placed nearer to the subscribers and away from the central site. The DSLAM of a conventional network is installed at the central site, where it is much easier to arrange the necessary power supply and where the environmental factors crucial for the equipment electronics (temperature and humidity) are easier to control. In an FTTC network topology, the remote DSLAM (subsequently RDSLAM) has to be installed, for example, in a box located at a street corner, where the power supply arrangement is laborious and where the electronics suffer from wide temperature and humidity variations. A substantial portion of the electronics of DSLAM equipment is located in the digital transceivers of the DSL modems and in the circuitry multiplexing the data stream onto the optical fiber. Also, a substantial amount of power consumption is used for supplying the said electronics. FIG. 1 represents a FTTC network topology based on known technology. An optical fiber 101 connects the RDSLAM equipment 102 to the central site equipment 100. At the central site, the fiber is connected to a switching device of the trunk network, e.g. an ATM switch or an IP router, depending on the transport protocol.

Another problem with FTTC topology arises from the fact that the data stream multiplexing of RDSLAM involves protocols, e.g. ATM switching or IP routing. Protocol dependency may turn out to be a problem if the original protocol cannot support new services in the future. In that case, it may be necessary to modernize all the RDSLAM equipment, causing considerable expenses to the network operator, because the number of RDSLAM units is inherently high.

The method of reference [1] succeeds in overcoming some of the problems described above. According to the method of reference, the analog interface of the DSL modems at the central site DSLAM is connected to the system, so that the central site equipment converts the modem analog signal into a digital sample sequence. The sample sequence is transmitted through an optical fiber to the far end and converted back into an analog signal, which is then fed into a twisted pair subscriber cable. The same procedure is carried out as well in the reverse transmission direction from the subscriber towards the central site. Hence, the system is entirely symmetrical, and identical equipment is needed at both ends of the optical fiber. Thus the interface between the system and the central site DSL modems is based on connecting analog signals in both transmission directions. An inherent problem of this method arises from the fact that there are altogether four line transformers along the signal transmission path between the central site DSL modem and the subscriber network-terminating unit. As a consequence, there are two more transformers in addition to the transformers included in the DSL modem and the network-terminating unit. Line transformers play a significant role in many DSL modem types because they alter the signal transmission path transfer function. Hence, the additional line transformers hamper the functioning of the modem considerably and may even prevent the modem operation. In addition, the method of reference requires cost adding electronics, including two additional analog-to-digital converters and two digital-to-analog converters for each subscriber connection. The method of reference comprises automatic signal gain control based on the signal level measured by the equipment itself. In practice, this kind of signal level control is not workable, because the level adjustment has to be based on calculation carried out by the digital receiver of the DSL modem. The method of reference does not enable this.

The objective of the present invention is to overcome the problems of prior-art technology and to provide an entirely novel method for establishing an FTTC subscriber network.

### SUMMARY OF THE INVENTION

The objective of the invention is to forge a solution enabling the subscriber connection to be established and especially the equipment at the subscriber end of the optical fiber to be implemented in as simple a way as possible.

The objective is achieved by the method according to the invention, characterized by what is stated in the characterizing part of claim 1, and by the system according to the invention, characterized by what is stated in the characterizing part of claim 9.

In the method according to the invention, the DSL modems of subscriber connections are implemented in a distributed manner so that the equipment at the subscriber end of the optical fiber comprises only the analog parts of the modems and a multiplexer element, which adapts the analog-to-digital and digital-to-analog converters included in the analog parts to the optical fiber.

In a preferred embodiment of the invention, the control information required by the analog parts are determined by the digital transmitter and receiver elements of the modems located at the central site, and the said control information is transmitted to the modem analog parts via an auxiliary channel over the optical fiber. There are many prior-art techniques for implementing the auxiliary channel. As described later, the auxiliary channel is virtually necessary for the present, but it may become unnecessary in the future.

In another preferred embodiment of the invention, the clock signals required with the method can be implemented so that all clocks are mutually synchronous, enabling a simple implementation, but on the other hand, it is required that all DSL modems connected to the system have to be identical.

In a third preferred embodiment of the invention, the clock signals required with the method can be implemented so that the transmitter and receiver clock signals of different modems need not have identical frequencies or be mutually synchronous, nor synchronous with other clocks in the system either. As a consequence, implementation is more complicated compared with the above-mentioned embodiment, but on the other hand, its advantage is that different types of DSL modems can be installed in the system.

Thus, in the method according to the invention, the required clock signals can be implemented in two different ways depending on what is preferred, simple implementation or resiliency.

In a fourth preferred embodiment of the invention, the line hybrid included in the analog parts can be coupled to the twisted pair cable without a line transformer.

In a fifth preferred embodiment of the invention, a conventional analog telephone connection can be implemented in the system.

The invention offers several substantial advantages.

In FTTC topology, the electronics of RDSLAM equipment installed in the hard environment at the subscriber end of the optical fiber can be made substantially simpler compared to conventional DSLAM equipment, and it can be made entirely independent of protocols related to data stream multiplexing.

The invention also provides means to use different types of DSL techniques in the same system.

In addition, the invention makes it possible to implement over the same twisted pair cable both a high speed DSL connection and an analog telephone connection, without mutual interference.

In the following, the invention will be examined in greater detail with the help of exemplifying embodiments and the appended drawings.

### LIST OF FIGURES

FIG. 1 represents the structure of a prior-art FTTC subscriber network and the RDSLAM equipment residing at the subscriber end of an optical fiber.

FIG. 2 depicts a principle of the invention whereby the equipment at the subscriber end of the fiber comprises only the analog parts of a DSL modem and the multiplexer which adapts the analog-to-digital and digital-to-analog converters to the optical fiber.

FIG. 3 shows details of the method according to the invention concerning the DSL modem connection of one subscriber.

FIG. 4 illustrates a principle of clocking implementation in accordance with the invention, in a case where all DSL modems are using the same sampling frequency.

FIG. 5 illustrates a principle of the invention which makes it possible to connect different types of DSL modems to the system so that the digital transmitters and receivers of separate DSL modems are able to use varying sampling frequencies.

FIG. 6 describes a principle of the invention where the analog parts located at the subscriber end of the optical fiber include a controllable gain stage.

FIG. 7 illustrates a principle in accordance with the invention which enables the analog parts to be coupled to the twisted pair cable without a line transformer.

FIG. 8 represents a principle of the invention which makes it possible to connect an analog telephone connection to the twisted pair cable of each subscriber.

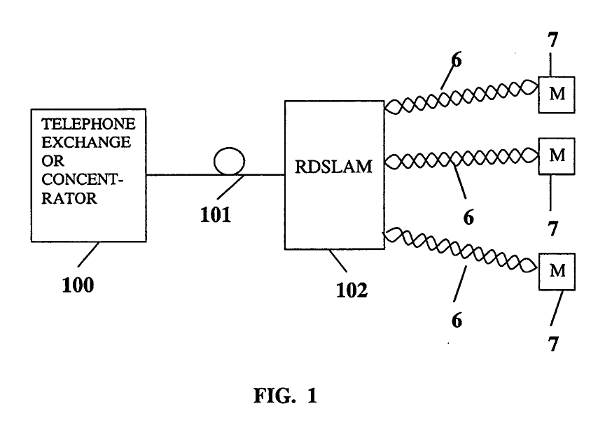

### DETAILED DESCRIPTION OF THE INVENTION

The following abbreviations are used in this document:

| | |
|---|---|
| AD converter | analog-to-digital converter |
| AGC | automatic gain control |
| ATM | asynchronous transfer mode |
| COMUX | central office multiplexer |
| DA converter | digital-to-analog converter |
| DSL | digital subscriber line |
| DSLAM | digital subscriber line access multiplexer |
| FTTC | “Fiber To The Curb”, “Fiber To The Cabinet”, |
| | subscriber network comprising an optical fiber and a |
| | metallic cable |
| IP | internet protocol |
| POTS | “Plain Old Telephone Service”, conventional telephone |
| | connection |
| RAFE | remote analog front end, analog parts residing at the far |
| | end |
| RDLAM | remote DSLAM of an FTTC network |

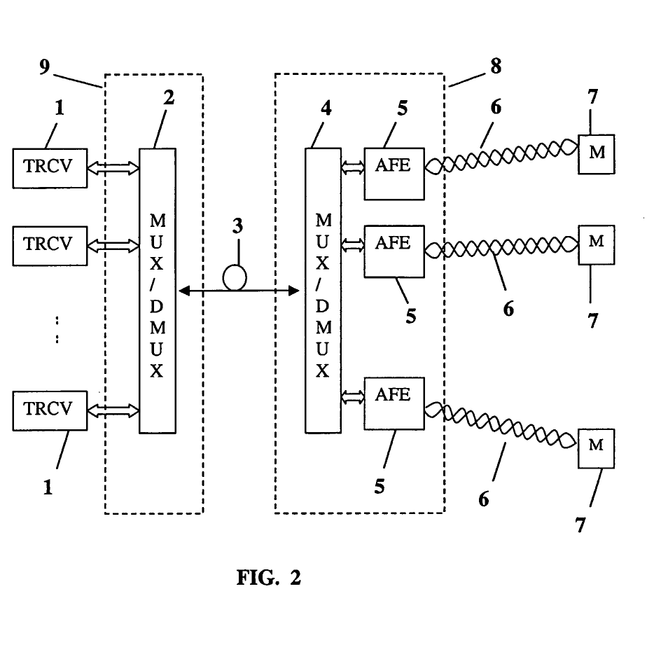

In the method according to the invention in FIG. 2, the equipment 8 needed at the subscriber end of the optical fiber and located, for example, in a street corner cabinet, comprises only the analog parts 5 of the DSL modems, so that digital signal processing of the modems is carried out by a transceiver element 1 located at the central site. A full-duplex optical fiber link 3 connects the transceiver element to equipment 8 and carries digital sample sequences transferred between the digital transceiver and the analog parts in both directions. The traffic from all subscriber cables concentrated at the fiber end is multiplexed to the fiber link. The network terminal unit 7 of each subscriber is located at the far end of each twisted pair cable 6. The said equipment 8 at the subscriber end of the fiber is subsequently referred to as RAFE (Remote Analog Front End).

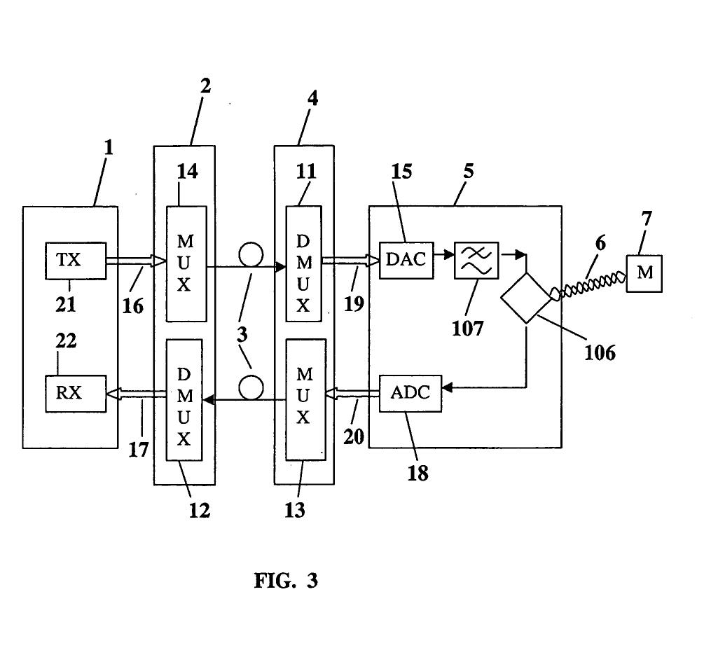

FIG. 3 illustrates details of the method. A DSL modem transmitter 21 at the central site generates a modulated signal 16 in digital form at a certain sampling frequency Of f_{CONV}. Signal 16 is represented with a bit accuracy sufficient for the modulation method in use, typically with about 12 bits. Digital sample sequences produced by several DSL modem transmitters are multiplexed by a multiplexer element 14 into a serial data stream with a sufficient bit rate. Multiplexing requires that a frame structure is added to the bit stream by the insertion of additional frame header bits. There are many ways to compose the frame structure, and the frame details are not essential for the operation of the method. In the following, it is assumed that N separate subscriber connections are transported over the single fiber link 3 and that the bit accuracy of the sample sequence produced by a transmitter is K bits. Furthermore, it is assumed that the number of bits in the frame header is M. With these symbols the bit rate of the multiplexed bit stream can be expressed as

f_{MUX}=(N+M/K)f_{CONV}

Subsequently, the multiplexer equipment 2, including its optical fiber interface, is referred to as COMUX (Central Office Multiplexer).

The bit stream, multiplexed by the COMUX, is transported through the fiber link 3 to the RAFE. In the RAFE, the frame structure is disassembled and the bit stream corresponding to each subscriber is separated in a demultiplexer 11 and then converted into a sample sequence 19 of K bit width, with a sampling frequency of f_{CONV}. The sample sequence 19 is fed into a digital-to-analog converter 15 (DA conversion). The output signal of the converter is filtered by a low-pass filter 107, which removes the folded spectral components of the signal. The signal is fed into the twisted pair cable 6 via a hybrid circuitry 106 furnished with a line transformer.

The signal produced by the network terminal unit 7 connected to the far end of twisted pair cable 6 is transferred through the transformer and hybrid 106 to an analog-to-digital converter 18 of the RAFE, which converts the signal into a digital sample sequence of sampling frequency f_{CONV} (AD conversion).

In the receiving direction the sample sequences coming from all subscriber connections are multiplexed by a multiplexer element 13 into a serial framed bit stream. The bit rate of the bit stream is f_{MUX}, provided that the AD conversion bit accuracy is the same as the accuracy of DA conversion in the transmitting direction and that the frame header length is equal to the header length of the transmitting direction. The bit accuracies in both directions do not need to be equal but this assumption is nevertheless made subsequently.

In the receiving direction, the multiplexed bit stream is transferred over fiber link 3 to the central site. There the frame structure is disassembled by a demultiplexer element 12, and sample sequences 17 corresponding to each subscriber connection are fed into the DSL modem receiver 22 of the respective subscriber connection.

System Clocks

The signal is transferred as sample sequences between subscriber-specific DSL modem transmitters and receivers, AD and DA converters, and the multiplexing elements. Hence a clock signal is needed for synchronizing the signal transfer. Thus the generation of clock signals plays an essential role in the system implementation.

Provided that the constraints are set so that all DSL modems are operating at the same nominal clock frequency and all clocks are synchronized, the clocks can be implemented in the following preferred way.

All the clocks of the system are synchronized with each other. As a consequence, the frequency ratio between each clock is a precise fraction. The ratio between each clock frequency is dependent on the used bit precision, the sampling frequencies, and the details of the bit stream frame structure on the fiber link. But in any case, the frequency ratio is always a precise fraction.

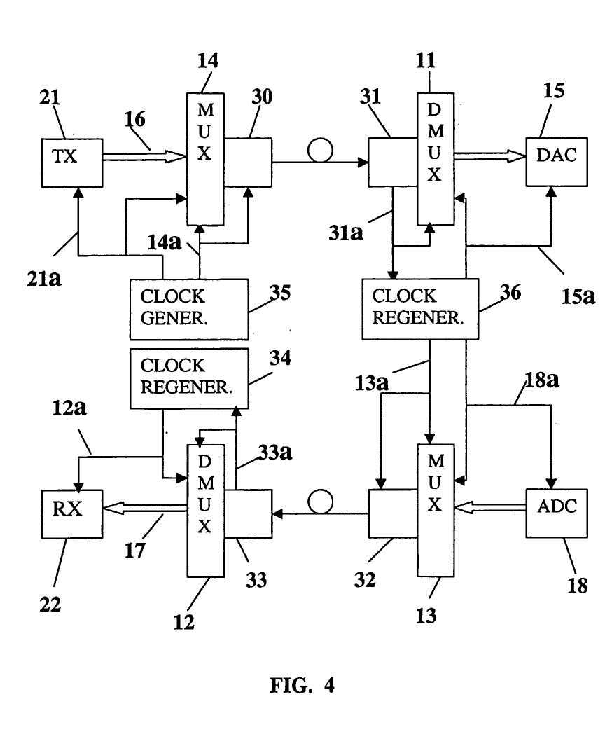

FIG. 4 illustrates detailed clocking implementation of the method in accordance with the invention. The frequency ratio of the multiplexed bit stream on the optical fiber link and the bit stream generated by a single DSL transmitter is a fixed ratio of two integers. A clock generator 35 included in the COMUX produces a sampling clock 21a for a DSL transmitter 21. The said clock 21a synchronizes the signal samples that are produced by the DSL transmitter and fed into the multiplexer 14. Hence it is essential that every DSL transmitter can synchronize itself to the clock provided by the COMUX. It is also necessary that every DSL modem uses the same sampling frequency. The clock generator 35 also generates a clock signal 14a for the multiplexer 14 and a fiber link transmitter 30. A fiber link receiver 31 regenerates a clock signal 31a based on the signal received from the fiber and gives the said regenerated clock signal to the demultiplexer 11 and a clock regenerator 36. The clock regenerator 36 produces clocks 13a, 15a, and 18a, which are synchronized to clock 31a. The multiplexer 13 and a fiber link transmitter 32 are using clock 13a. Clock 15a is used by DA converter 15 as a sampling clock and by demultiplexer 11 for synchronizing the sample sequence it feeds into the DA converter. Clock 18a is used by AD converter 18 as a sampling clock which also synchronizes the converted digital signal for feeding into the multiplexer 13. The multiplexer 13 receives samples synchronized by the clock 18a. Based on the signal received from the fiber, the fiber link receiver 33 regenerates a clock 33a, which is given to a demultiplexer 12 and a clock regenerator 34. The said clock regenerator 34 produces a clock 12a, synchronized to clock 33a. The said clock 12a is used by the demultiplexer 12 for synchronizing the sample sequence it gives to the receiver 22 of the COMUX. Accordingly, the clock generator 35 of the COMUX is the source of every clock included in the system. Generating the clocks in accordance with the above techniques is simple. But on the other hand, certain demands are made considering to the DSL modems installed in the system.

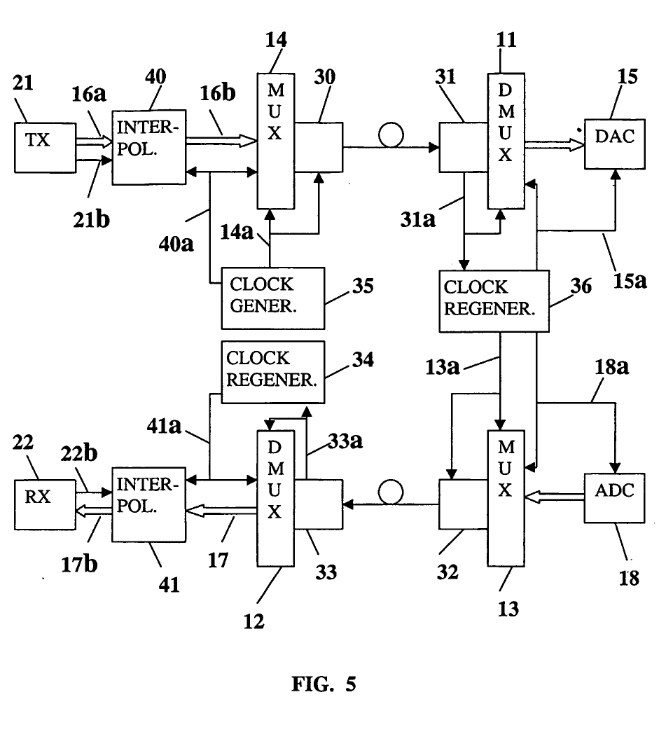

The clocking principle described in FIG. 4 presumes that the sampling frequency of every DSL transmitter and receiver is equal and that the clocks are synchronized. As a consequence, it is not possible to install different types of DSL equipment with different sampling frequencies in the system. FIG. 5 represents another preferred embodiment of the invention, which makes it possible for DSL transmitters and receivers to be connected to the system using sampling clocks generated by the transmitters and receivers themselves. The frequency of these clocks need not have a fixed ratio with the COMUX clocks.

FIG. 5 shows a digital interpolator element 40 connected between a DSL transmitter 21 and a multiplexer 14. The said interpolator element is based on digital filtering and converts the sample sequence 16a produced by the DSL transmitter in synchronism with a clock 21b, which is generated by the DSL transmitter as well, into another sample sequence 16b, which is synchronized to a clock 40a given by the clock generator 35. In the receiving direction, an interpolator element 40 converts the sample sequence 17 coming from the demultiplexer 12 and synchronized to clock 41a into another sample sequence 17b, which is synchronized to a clock 22b generated by the DSL receiver 22. There are many alternate techniques for implementing the interpolator elements 40 and 41 (e.g. reference [2]). Interpolator implementation is not essential for the operation of the system. In other respects the clocking arrangement remains the same as in FIG. 4.

The method in FIG. 5 makes it possible to install DSL modems of different types in the system, provided that the analog-to-digital and digital-to-analog conversions are running at a sufficiently high sampling frequency with respect to each DSL modem. The method also makes it possible for several service providers to connect their own DSL equipment to the system. In addition, this enables the encompassing of FTTC subscriber connections for competition between several service providers, which is also the objective of legislation in many countries.

Automatic Gain Control and Transfer of Control Information for Analog Parts

The systems depicted in FIG. 2-5 can utilize an analog-to-digital converter 18 with such high precision that the twisted pair cable is allowed to attenuate the signal considerably. In that case the signal, transmitted by network terminal unit 7 and attenuated by cable 6, can be converted into digital form so that the quantization noise of the converter does not cause too much interference in signal detection in the receiver 22. The required bit accuracy of the converter is greatly dependent on the modulation method used by the modem and on the maximum allowable attenuation of the cable. Hence, very high converter precision may be required, and it is evident that the state-of-the-art converter technology does not provide sufficient precision at the cost level required by volume production. An example of this is the analog-to-digital converter of a VDSL modem, where the required bit accuracy is about 16 bits if the converter is not equipped with AGC (Automatic gain Control) circuitry controlled by the receiver. The AGC circuitry, based on an analog amplifier in front of the analog-to-digital converter, amplifies the signal in the input of the converter so that the converter converts a signal at a level as high as possible. Hence, converter precision is utilized maximally regardless of the length of the cable 6. In the VDSL modem case, cited as an example, sufficient converter accuracy is around 12-13 bits if the receiver is equipped with an AGC circuitry. In that case, the realization of the converter is notably easier, the manufacturing cost lower, and the converter power consumption lower. As the AD converter technology improves and the bit accuracies become higher, it may eventually be unnecessary to utilize a controlled AGC circuitry, even in the VDSL case cited as an example.

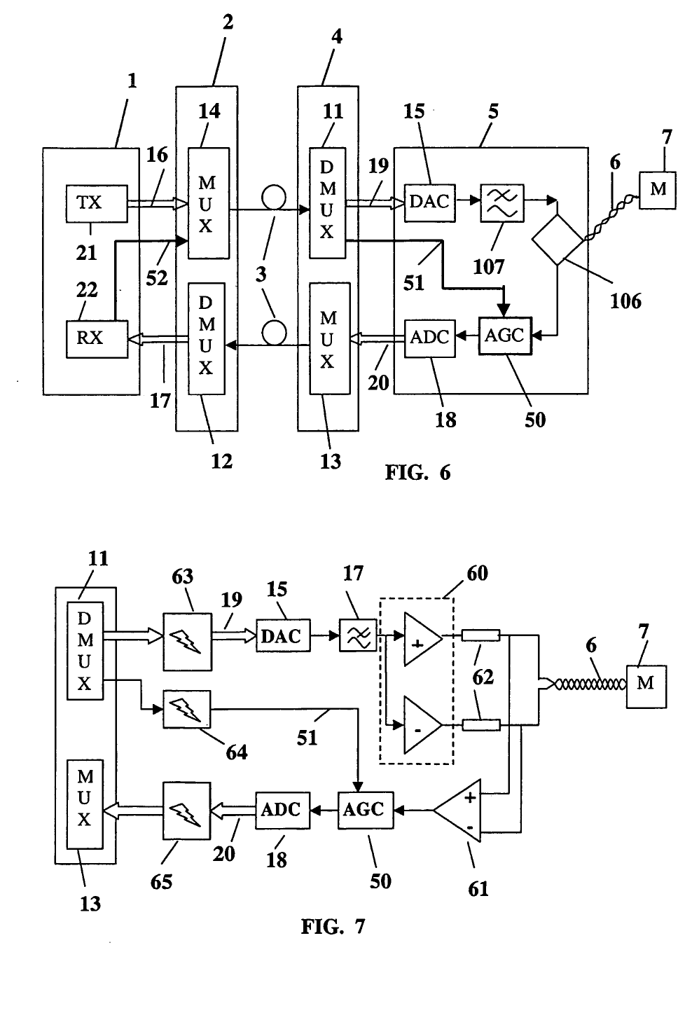

It is necessary that the AGC circuitry is controlled by the DSL receiver 22 residing at the central site, because what is the proper gain is not known in advance. Except for very simple modulation methods or line codes (e.g. HDB3 line code), which do not require a special start-up or handshaking phase, the gain cannot be controlled on the basis of the signal level measured in the RAFE either, because the training phase comprises periods when the gain must definitely be constant. In a preferred embodiment of the invention, an auxiliary channel is implemented over the fiber link in order to enable each DSL receiver to control the AGC circuitry of the analog parts 5 belonging to the corresponding subscriber connection. There are many ways to implement the auxiliary channel, e.g. by utilizing a wavelength multiplexing on the fiber link, and the implementation principle is not essential for the operation of the method according to the invention. In a preferred embodiment of the invention, the auxiliary control channel is implemented by inserting control channel bits for each subscriber connection in the frame structure. FIG. 6 illustrates the details of this preferred embodiment. As already mentioned above, improvements, especially in AD conversion technology, may make it possible to manage without control information being sent to the analog parts of the modem. In that case no auxiliary channel is needed over the fiber link.

In FIG. 6 the receiver 22 transmits the control data for an AGC circuitry 50 through a digital interface 52 to the multiplexer 14. The multiplexer inserts the level adjustment data bits into the frame structure of the data stream transported over the fiber link 3. The demultiplexer 11 picks up the level adjustment data 51 for each subscriber connection from the frame structure and hands them over to the AGC circuitry 50.

In the method according to the invention, the digital transmitter and receiver at the central site may also utilize the auxiliary channel for controlling other functions of the analog parts. For example, the output signal of the digital-to-analog converter can be looped directly to the input of the analog-to-digital converter (local loop). Thus, it is possible to test the operation of the converters from the central site during the installation of the equipment.

Removing the Line Transformer

In FIGS. 3 and 6 the hybrid element 106 is shown comprising a line transformer which conveys the transmitter signal into pair cable 6 and which also conveys the received signal from the pair cable to the AD converter or potential AGC circuitry. The main task of the line transformer is to provide over-voltage protection in order to protect the analog parts from high voltage pulses, e.g. induced by lightning strokes. Another task of the transformer is to attenuate longitudinal noise voltage induced in the cable. In addition to the above-mentioned tasks, the line transformer is an integral part of the signal path influencing the signal transfer function. For example, in an echo canceling DSL modem, in conjunction with the line driver feeder resistance and the pair cable impedance, the line transformer forms a high-pass filter, which has a substantial effect on the temporal length of the echo response reflected from the hybrid. Hence, selection of the magnitude for the main inductance of the line transformer is crucial for an echo canceling modem. Another example of the importance of line transformer inductance is an ADSL modem, where a proper inductance magnitude is chosen in order to have an advantageous influence on signal transfer function and channel equalization.

Because the magnitude of the line transformer main inductance greatly depends on the type of DSL modem is use, the inductance dependency constitutes a substantial drawback for the method of the present invention. The fact that the optimal transformer is dependent on the type of DSL modem considerably decreases universal applicability of the method.

FIG. 7 illustrates a preferred embodiment of the line hybrid of a RAFE where no line transformer is needed. Pair cable 6 is coupled directly to the differential output of a line driver 60 without any line transformer. The signal, received from the network terminal unit 7, is connected to a differential amplifier 61. The differential amplifier efficiently attenuates the common mode noise signal. The effect of a line transformer on the signal transfer function is imitated by means of digital filtering, both by the transmitter and the receiver at the central cite (transmitter 21 and receiver 22 for example in FIG. 6). The digital filtering can be adapted to be optimal for the DSL modem in use. An alternative site for the line transformer imitating digital filtering is the multiplexer 14 and demultiplexer 12 of the COMUX. Another alternate site for digital filtering is the demultiplexer 11 and multiplexer 13 of the RAFE. In so far as the digital filtering takes place in the RAFE and DSL modems of different types are installed in the system, the digital filtering must be programmable over the fiber link via an auxiliary channel. In this way, the problem arising from a fixed line transformer inductance and different installed modem types is effectively resolved.

The whole line interface circuitry is protected from over-voltage by isolating it galvanically from other circuitry by means of over-voltage insulators 63, 64, and 65. These insulators isolate signals 19 and 51 coupled to the DA converter and AGC circuitry from the demultiplexer 11, and the output signal 20 of the AD converter from the multiplexer 13. There are many alternate means of implementing these over-voltage insulators, and the implementation details are not essential for the operation of the method. The insulation might be based on inductive or capacitive signal coupling or an opto-isolator. The power feed over the insulating boundary for the isolated electronics has to be arranged through inductive coupling by a transformer of a switched-mode power supply.

Connecting a Telephone Service to the System

According to prior-art technology, a conventional subscriber connection or a POTS connection (Plain Old Telephone Service) can be connected to the same pair cable with a DSL modem in so far as such line code or modulation method is applied by the modem that the frequency ranges of the telephone signal (about 100-3000 Hz) and the DSL modem signal do not overlap. An example is an ADSL modem which can be connected to the same pair cable with a telephone set by means of a so-called splitter filter that separates the telephone and modem signals.

A POTS can be connected to a system according to the present invention in the following way. In the central site COMUX, the telephone signal is converted into a digital sample sequence with the same sampling frequency that the DSL transmitter 21 uses when feeding its own output signal to the multiplexer 14. The sampled telephone signal is added together with the DSL transmitter output signal 16. The said phone signal is converted into analog form by the DA converter 15 of the RAFE. In this case the transformless analog parts of FIG. 7 should be applied, because the line transformer inductance of a DSL modem is far too low for the telephone signal and would practically short-circuit the telephone signal.

In the reverse direction, it would be possible to use the AD converter 18 of the RAFE for converting the telephone signal and then filter apart the said signal after demultiplexing 12 in the COMUX. In practice, problems would arise because a very high-level telephone signal might overload the AD converter 18 so that the DSL modem signal would be distorted and bit error bursts would occur as a consequence. The telephone signal also increases the dynamic range of the AD converter input signal. Hence, the bit accuracy of the AD converter should be added, which would increase power consumption and component costs.

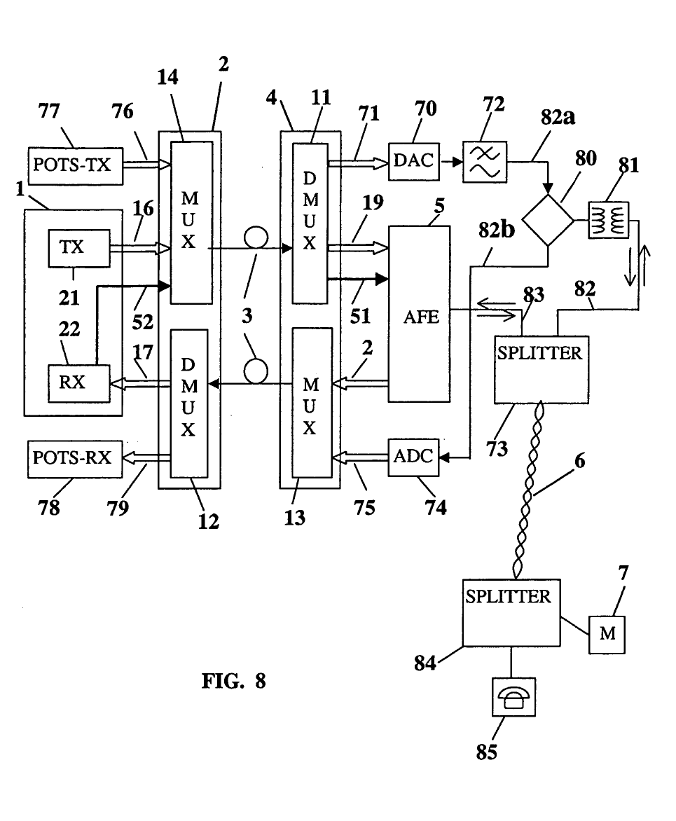

The problems described above can be overcome by applying the method depicted in FIG. 8. The method is based on transferring the telephone signal over the optical fiber in a digital sampled form by using a subscriber-specific auxiliary channel and separate AD and DA converters for converting the telephone signal. The auxiliary channel can be implemented by various means, e.g. by utilizing wavelength multiplexing on the optical fiber. A preferred embodiment of the auxiliary channel, as shown in FIG. 8, exploits the frame structure used over the fiber link by multiplexing the said sampled telephone signal and inserting the multiplexed stream into the frame structure.

In the embodiment shown in FIG. 8, a standard compliant subscriber-specific telephone signal (e.g. in analog form or in accordance with the recommendation G.704), coming from a telephone exchange, is converted into a digital sample sequence 76 at an appropriate sampling frequency in a functional block 77. The said sample sequence is multiplexed (14) into the frame transferred over the fiber link so that the demultiplexer 11 of the RAFE can pick up the subscriber-specific telephone channel bits for each subscriber and feed them in a form of digital sample sequence 71 to a digital-to-analog converter 70. A low-pass filter 72 filters the output signal of the said converter, and the filtered signal is fed into a line transformer 81 through a two-wire/four-wire hybrid 80. The analog parts of the DSL modem, equipped with a transformer (according to FIGS. 3 and 6) or without a transformer (according to FIG. 7), are included in the AFE block 5 (Analog Front End). A splitter filter 73, consisting of passive components, mixes the DSL modem signal 83 and the telephone signal 82 and feeds the mixed signal into the pair cable 6. From the signal coming from the far end of the pair cable, the said splitter filter filters apart the telephone signal 82, concentrated at lower frequencies, and the modem signal 83, concentrated at higher frequencies. The telephone signal is fed to an analog-to-digital converter 74 through the hybrid 80, and the modem signal 83 is coupled to the AFE block 5. The said AD converter 74 produces a sample sequence 75, which is fed into the multiplexer 13 that multiplexes the telephone channel bits into the frame transferred over the fiber link. The demultiplexer 12 of the central site COMUX picks up subscriber-specific telephone channel bits from the frame. A functional block 78 converts the telephone channel sample sequence into such a form that the signal can be fed into a telephone exchange. At the subscriber end of the pair cable, a splitter filter 84 is needed for filtering apart the signals of network terminal 7 and a telephone set 85. The filtering arrangement at the subscriber end and the splitter filter 73 are known technology, as utilized in ADSL modem connections, for example.

In the system in accordance to the method described above, the inductance and other properties of the line transformer conveying the telephone signal can be chosen to be optimal for the telephone signal, and this transformer has no deteriorating influence on the DSL modem signal.

Although the above description of the invention refers to the examples in the accompanying drawings, it is apparent to an expert in the field that the invention is not limited by the examples but that various modifications are possible within the scope of the invention claimed. For example, the fiber link may comprise several full-duplex fibers or there may be separate fibers for both transmission directions.

### REFERENCES

[1] U.S. Pat. No. 5,526,154, Method of establishing a subscriber connection and a subscriber network. [2] Heinrich Meyer, Marc Moenelaey, Stefan A. Fechtel, Digital Communication Receivers, John Wiley & Sons, Inc.

1. A method for establishing a digital subscriber connection by means of subscriber-specific DSL modems, in which method (a) a subscriber connection comprises an optical fiber (3), a metallic pair cable (6), and equipment (8) adapting the said fiber and cable to each other so that the optical fiber goes towards the central site and the pair cable goes towards the subscriber, and (b) each DSL modem comprises digital transmitter and receiver elements (21, 22), connected functionally to analog parts (5) that are adapted to convert (i) the digital output signal of the digital transmitter element (21) into analog form and (ii) the analog signal, intended for the receiver element (22), into digital form,
the method comprising the steps of
transferring the first signal, being in digital form, over the optical fiber (3) from the central site to the said equipment (8),
converting the first signal, being in digital form, into analog form in the said equipment (8) and feeding the first signal, being in analog form, further into the pair cable (6),
converting the second signal, received from the subscriber through the pair cable (6), into digital form in said equipment (8),
sending the second signal, being in digital form, to the central site from said equipment (8) through the optical fiber, and
multiplexing the first and second signals of several subscriber connections, being in digital form, onto at least one optical fiber,
characterized by
inserting the analog parts (5) of the DSL modems in said equipment (8), transferring the output signal of the DSL modem digital transmitter element (21) to the respective analog parts (5), and transferring the output signal of the DSL modem analog parts (5) to the respective digital receiver (22) through the optical fiber (3).

2. A method according to claim 1, characterized in that the control information for the analog parts (5) is determined in the digital transmitter and receiver elements (21, 22) located at the central site, and that said information is transferred to the analog parts through an auxiliary channel arranged over the optical fiber (3).

3. A method according to claim 1, characterized in that the analog parts (5) of the DSL modem comprise a digital-to-analog converter (15), an analog-to-digital converter (18), a line driver and line hybrid, and other essential electronics related to these elements, and that the output signal of the digital transmitter element (21) is transferred to the said digital-to-analog converter and the output signal of the said analog-to-digital converter is transferred to the digital receiver element (22) through the optical fiber.

4. A method according to claim 3, characterized by
adapting a first clock generator (35) to produce sampling clocks for all digital transmitter elements and a clock for an optical fiber transmitter (30) at the central site,
adapting a first regenerator element (34) to produce sampling clocks for all digital receiver elements based on the clock regenerated by an optical fiber receiver (33) at the central site, and
adapting a second regenerator element (36), based on the clock regenerated by an optical fiber receiver in the equipment (8), to produce sampling clocks for the digital-to-analog converters and analog-to-digital converters and a clock for an optical fiber transmitter (32) in the equipment (8).

5. A method according to claim 3, characterized by
making the clocks of the analog-to-digital converters, digital-to-analog-converters, and the optical fiber synchronous among themselves,
adapting the digital transmitter element (21) of each subscriber connection to generate a first sampling clock (21b) and to produce a first sample sequence (16a) synchronized with this clock, and
by adapting the digital receiver element (22) to generate a second sampling clock (22b) and to receive a second sample sequence (17b) synchronized with this clock.

6. A method according to claim 5, characterized by
adapting the first clock generator (35) to generate a third sampling clock (40a) for synchronizing a third sample sequence (16b), which is generated at the central site and directed to the digital-to-analog converter of each subscriber connection, and further to generate a clock for the central site transmitter (30),
adapting the first regenerator element (34), based on the clock regenerated by the central site optical fiber receiver (33), to generate a fourth sampling clock (41a) for synchronizing a fourth sample sequence (17) received from the analog-to-digital converter of each subscriber connection,
adapting the second regenerator element (36), based on the clock regenerated by the optical fiber receiver (31) of the equipment (8), to produce sampling clocks for the digital-to-analog converters and analog-to-digital converters and to produce a clock for the optical fiber transmitter (32) of the equipment (8),
adapting a first interpolator element (40) to convert the first sample sequence (16a), synchronized with the first sampling clock (21b), into the third sample sequence (16b) synchronized with the third sampling clock (40a), and
adapting a second interpolator element (41) to convert the fourth sample sequence (17), synchronized with the fourth sampling clock (41a), into the second sample sequence (17b) synchronized with the second sampling clock (22b).

7. A method according to claim 3, characterized by implementing the line hybrid (106) of the analog parts (5) by
isolating the analog-to-digital and digital-to-analog converter galvanically from the multiplexing elements (11) and (13) related to the analog parts by means of over-voltage isolators (63, 64 and 65),
connecting functionally the digital-to-analog converter output to a differential line driver (60) and coupling galvanically the non-inverting and inverting output of said line driver to the pair cable (6) through feed resistors (62), and
coupling the pair cable (6) galvanically to the input of a differential amplifier (61) and coupling the output of the said differential amplifier functionally to the analog-to-digital converter (18).

8. A method according to claim 2, the method comprising the steps of transferring both a full duplex modem signal and a full duplex voice-frequency telephone signal through a subscriber connection,
characterized by implementing the signal transmission by
adapting a first conversion element (77) at the central site to convert the standard compliant telephone signal of each subscriber to a digital sample sequence (76) and transferring said sample sequence through the optical fiber by means of a subscriber-specific auxiliary channel,
in the equipment (8), feeding the sampled telephone signal (71) to a separate digital-to-analog converter (70), which converts the telephone signal into analog form,
adapting a splitter filter (73), coupled to the equipment (8) end of the pair cable (6), to filter apart a full duplex modem signal (83) and a full duplex telephone signal (82),
coupling the telephone signal (82) to the splitter filter (73) by means of a separate hybrid (80) and a transformer optimized for the telephone signal,
coupling the modem signal (83) from the splitter filter to the analog parts (5) of the modem,
converting a telephone signal (82b), received from the pair cable through the said separate hybrid (80), to a sample sequence (75) by means of a separate analog-to-digital converter (74),
transferring the sample sequence (75), originating from the pair cable of each subscriber connection, through the optical fiber to the central site by means of a subscriber-specific auxiliary channel, and
adapting a second converter element (78) to convert a sampled telephone signal (79), transferred over the optical fiber, to a standard compliant form.

9. A system for establishing a digital subscriber connection, consisting of a composition of an optical fiber and a metallic pair cable, by means of subscriber-specific DSL modems, in which system (a) a subscriber connection comprises an optical fiber (3), a metallic pair cable (6), and equipment (8) adapting the said fiber and cable to each other so that the optical fiber goes towards the central site and the pair cable goes towards the subscriber and (b) each DSL modem comprises digital transmitter and receiver elements (21, 22), coupled functionally to analog parts (5) that are adapted to convert (i) the digital output signal of the digital transmitter element (21) into analog form and (ii) the analog signal, intended for the receiver element (22), into digital form,
the system comprising
means for transferring the first signal, being in digital form, over the optical fiber (3) from the central site to the said equipment (8) located closer to the subscriber and connected to at least one subscriber-specific pair cable (6),
characterized in that
the said equipment (8) comprises the analog parts (5) of the DSL modems, and the said analog parts are adapted to receive the digital signal, transmitted by the digital transmitter element (21), from the optical fiber, and to send the digital signal, intended for the digital receiver element (22), to the optical fiber.

10. A system according to claim 9, characterized in that
the digital transmitter and receiver elements (21, 22) of the DSL modems, located at the central site, comprise means for determining the control information needed by the analog parts, and
at least one auxiliary channel is implemented over the optical fiber link (3) for transferring the control information from said transmitter and receiver elements to said analog parts (5).

11. A system according to claim 9, characterized in that the analog parts (5) of a DSL modem comprise an analog-to-digital converter, a digital-to-analog converter, a line driver and line hybrid, and other essential electronics related to the said elements, respective to each subscriber.

12. A system according to claim 11, characterized in that
a first clock generator (35) is adapted to generate sampling clocks for all digital transmitter elements and a clock for an optical fiber transmitter (30) at the central site,
a first regenerator element (34) is adapted to generate sampling clocks for all digital receiver elements based on the clock regenerated by an optical fiber receiver (33) at the central site,
a second regenerator element (36) is adapted to generate, based on the clock regenerated by an optical fiber receiver in the equipment (8), sampling clocks for the digital-to-analog converters, the analog-to-digital converters, and a clock for an optical fiber transmitter in the equipment (8).

13. A system according to claim 11, characterized in that
the clocks of the analog-to-digital converters, digital-to-analog converters, and the optical fiber are made synchronous to one another,
the digital transmitter element of each subscriber connection is adapted to generate a first sampling clock (21b) and to produce a first sample sequence (16a) synchronized to said first sampling clock, and
the digital receiver element of each subscriber connection is adapted to generate a second sampling clock (22b) and receive a second sample sequence (17b) synchronized to said second sampling clock.

14. A system according to claim 13, characterized in that
the first clock generator (35) is adapted to generate a third sampling clock (40a) for synchronizing a third sample sequence (16b), produced at the central site and directed to the digital-to-analog converter of each subscriber connection, and further to generate a clock for the optical fiber transmitter (30) at the central site,
the first regenerator element (34) is adapted to generate, based on the clock regenerated by the optical fiber receiver (33) at the central site, a fourth sampling clock (41a) for synchronizing a fourth sample sequence (17) received from the analog-to-digital converter of each subscriber connection,
the second regenerator element (36) is adapted to generate, based on the clock regenerated by the optical fiber receiver (31) in the equipment (8), sampling clocks for the digital-to-analog converter and analog-to-digital converter, and further a clock for the optical fiber transmitter in the equipment (8),
a first interpolator element (40) is adapted to convert the first sample sequence (16a), synchronized to the first sampling clock (21b), into the third sample sequence (16b), synchronized to the third sampling clock (40a), and
a second interpolator element (41) is adapted to convert the fourth sample sequence (17), synchronized to the fourth sampling clock (41a), into the second sample sequence (17b), synchronized to the second sampling clock (22b).

15. A system according to claim 11, characterized in that the line hybrid (106) of the analog parts (5) is implemented by
isolating the analog-to-digital and digital-to-analog converter from multiplexing elements (11 and 13) related to the analog parts by means of over-voltage isolators (63, 64 and 65),
connecting functionally the output of the digital-to-analog converter to a differential line driver (60), coupling the non-inverting and inverting output of said line driver galvanically through feeding resistors to the pair cable (6), and
coupling the pair cable (6) galvanically to the input of a differential amplifier (61), and further connecting the output of the differential amplifier functionally to the analog-to-digital converter.

16. A system according to claim 10, the method comprising means for transferring both a full duplex modem signal and a full duplex voice frequency telephone signal in the system, characterized in that the said means comprise
at the central site a first converter element (77), which is adapted to convert the standard compliant telephone signal of each connection into a digital sample sequence (76),
connection-specific auxiliary channels implemented on the optical fiber link for transferring the telephone signal through the optical fiber,
a separate digital-to-analog converter (70) in the equipment (8) for converting the sampled telephone signal (71) into analog form,
a splitter filter (73) coupled to the equipment (8) end of the pair cable (6) and adapted to filter apart a full duplex modem signal (83) and a full duplex telephone signal (82),
a separate hybrid (80) and a separate transformer (81) optimized for a telephone signal, which are adapted to couple the telephone signal (82) to the splitter filter (73),
means for coupling the modem signal (83) from the splitter filter to the analog parts (5),
a separate analog-to-digital converter (74) for converting a telephone signal (82b), received from the pair cable through the said separate hybrid (80), into a sampled telephone signal (75) for transferring through the said auxiliary channel, and
at the central site a second converter element (78), which is adapted to convert a sampled telephone signal (79), transferred through the auxiliary channel, into a standard compliant form.
